(19) United States
(12) Patent Application Publication
(10) Pub. No.: US 2020/0072386 A1
(43) Pub. Date: Mar. 5, 2020

(54) Jack Head Isolator

(71) Applicant: Jonathan Edward George, Willis, TX (US)

(72) Inventor: Jonathan Edward George, Willis, TX (US)

(21) Appl. No.: 16/560,445

(22) Filed: Sep. 4, 2019

Related U.S. Application Data
(63) Continuation-in-part of application No. 29/699,815, filed on Jul. 29, 2019.
(60) Provisional application No. 62/726,801, filed on Sep. 4, 2018.

(51) Int. Cl. F16L 1/06

(52) U.S. Cl. CPC F16L 1/06

(57) ABSTRACT

A modular jack head isolator apparatus offers a buffer between a pipe-jack stand head and a workpiece such as piping to mitigate potential damages facilitated therebetween. The apparatus uses major planar members joined by a vertex and hooks to situate upon the pipe-jack stand head by sliding the hooks thereon. The apparatus offers a telescoping member for each of the major planar members, fitting onto a wider pipe-jack stand head. A locking hinge can modularly alter the inclination between the first and second major planar members to suit any angle of the pipe-jack stand head or other V-groove implement. Further, the apparatus uses magnets to attract to the metallic pipe-jack stand and resist slipping therefrom. Thus, the apparatus addresses the immediate damage that transpires between the piping workpiece and the pipe-jack stand head while providing various features to make the apparatus substantially universal.

The current application claims a priority to the U.S. Provisional Patent application Ser. No. 62/726,801 filed on Sep. 4, 2018.

### FIELD OF THE INVENTION

The present invention relates generally to sleeves. More particularly, the present invention is an isolator sleeve device secured atop a pipe-jack stand, V-groove implement, or similar to isolate the implement from another supported element.

### BACKGROUND OF THE INVENTION

Presently, workpiece such as piping, and fabrication/manipulation thereof must be fielded by a pipe-jack stand that conventionally uses a V-groove head to situate the piping thereon. However, the conventional material of the pipe-jack stand is generally mild carbon steel. This can prove detrimental to a workpiece including stainless-steel piping as the contact therewith may cause damage to the piping. Yet it is required that the pipe-jack stand be of considerable strength and thus conventionally using mild carbon steel. Therefore, there is a need to improve the conventional pipe-jack stands to provide protection of workpiece such as stainless-steel piping against undesired damages while being supported by and worked on the pipe-jack stand.

It is an objective of the present invention to provide a modular jack head isolator apparatus that comprises a first major planar member, a second major planar member, a first hook, a second hook, and a vertex, to situate upon any conventional pipe-jack stand head by sliding thereon through the front with the distal ends of the pipe-jack stand flush to the first hook and the second hook. Thus, the modular jack head isolator apparatus of the present invention can offer a buffer between the pipe-jack stand head and the piping element and consequently mitigating the potential damages facilitated therebetween. The present invention may provide a plurality of options that can make the jack head isolator apparatus substantially universal such as through an optional telescoping member for each of the first and second major planar members, permitting a wider pipe-jack stand head to be used with the present invention. A locking hinge permits the jack head isolator apparatus of the present invention to modularly alter the inclination between the first and second major planar members, which are joined by an vertex, and thus suit any angle of a pipe-jack stand head or other V-groove implement. Further, the jack head isolator apparatus may be granted a plurality of magnets that are secured within a plurality of magnet cavities, where the magnets thereof attract to the metallic pipe-jack stand and resist slipping therefrom. Thus, the present invention provides comprehensively a preferred embodiment that addresses the immediate damage that transpires between the piping workpiece and the pipe-jack stand head for particular applications through an isolator that separates the aforementioned, while further affording a plurality of optional features that can render the jack head isolator apparatus significantly universal to a number of V-groove implements.

### SUMMARY OF THE INVENTION

The jack stand head isolator apparatus provides a modular apparatus that comprises a first major planar member, a second major planar member, a first hook, a second hook, and a vertex, to situate upon any conventional pipe-jack stand head and/or V-groove implement by sliding the hooks thereon through the front of the distal ends of the pipe-jack stand flush to the first hook and the second hook. Thus, the modular jack head isolator apparatus can offer a buffer between the pipe-jack stand head and the piping element and consequently mitigating the potential damages facilitated therebetween. The modular jack head isolator apparatus can provide various features that can make the jack head isolator apparatus substantially universal such as through a telescoping member for each of the first and second major planar members, permitting a wider pipe-jack stand head to be used with the modular jack head isolator apparatus. The telescoping member may include retractable locking pins and pin holes to allow the jack head isolator apparatus to slidably extend to the suitable length and lock to secure on the pipe-jack stand head or V-groove implement.

Installed on the vertex, a locking hinge permits the jack head isolator apparatus to modularly alter the inclination between the first and second major planar members, which are joined by the hinge, and thus suit any angle of a pipe-jack stand head or other V-groove implement. The jack head isolator apparatus may be granted a plurality of magnets that is secured within a plurality of magnet cavities, where the magnets thereof attract to the metallic pipe-jack stand and resist slipping therefrom. Further, the present invention may provide a column recess on the edge of each of the first and second hooks, nearest the center of the apparatus, where consequently a composite profile is formed to suit a central columnar element of the extraneous pipe-jack stand or other V-groove implement with a columnar support thereunder.

Thus, the present invention provides comprehensively various embodiments that address the immediate damage that transpires between the piping workpiece and the pipe-jack stand head for particular applications through an isolator that separates the aforementioned, while further affording a variety of features that can render the jack head isolator apparatus significantly universal to various jack stands and/or V-groove implements.

### BRIEF DESCRIPTION OF THE DRAWINGS

FIG. 1 is a perspective view of the apparatus in the preferred embodiment of the present invention.

FIG. 2 is a front view of the apparatus in the preferred embodiment of the present invention.

FIG. 3 is a perspective view of an embodiment with telescoping major planar members of the present invention.

FIG. 4 is a bottom view of the embodiment with telescoping major planar members of the present invention.

FIG. 5 is a bottom perspective view of another embodiment with magnet cavities on major planar members of the present invention.

FIG. 6 is a perspective view of another embodiment with a locking hinge at the vertex of major planar members of the present invention.

FIG. 7 is a bottom perspective view of another embodiment with a column recess on each of the first and second major planar members of the present invention.

FIG. 8 is a front view of the embodiment with the column recess on each of the first and second major planar members of the present invention.

### DETAIL DESCRIPTIONS OF THE INVENTION

All illustrations of the drawings are for the purpose of describing selected versions of the present invention and are not intended to limit the scope of the present invention.

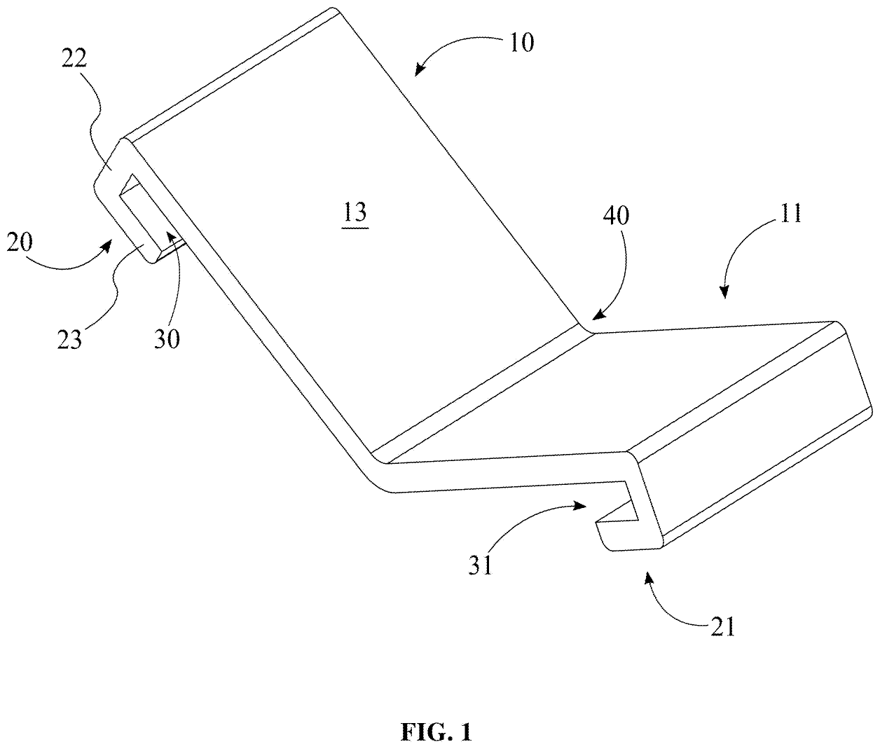

As can be seen in FIG. 1 to FIG. 8, the present invention comprises a modular jack head isolator that offers a buffer between a pipe-jack stand head and a workpiece such as a stainless-steel pipe and consequently mitigating the potential damages facilitated therebetween. The present invention may provide a plurality of features that can make the jack head isolator apparatus substantially universal. More specifically, the present invention may offer a telescoping member for each of a first planar member and a second major planar member, permitting a wider pipe-jack stand head to be used with the present invention. A locking hinge can be used to permit the jack head isolator apparatus of the present invention to modularly alter the inclination between the first and second major planar members, which joined by the hinge, and thus suit any angle of the pipe-jack stand head or other V-groove implement. Additionally, the jack head isolator apparatus may incorporate a plurality of magnets that is secured within a plurality of magnet cavities, where the magnets thereof attract to the metallic pipe-jack stand and resist slipping therefrom. Further, the present invention may provide a column recess on the edge of each of a first hook and a second hook, nearest the center of the back of the apparatus, where consequently a composite profile is formed to suit a central columnar element of the extraneous pipe-jack stand or other V-groove implement with a columnar support thereunder.

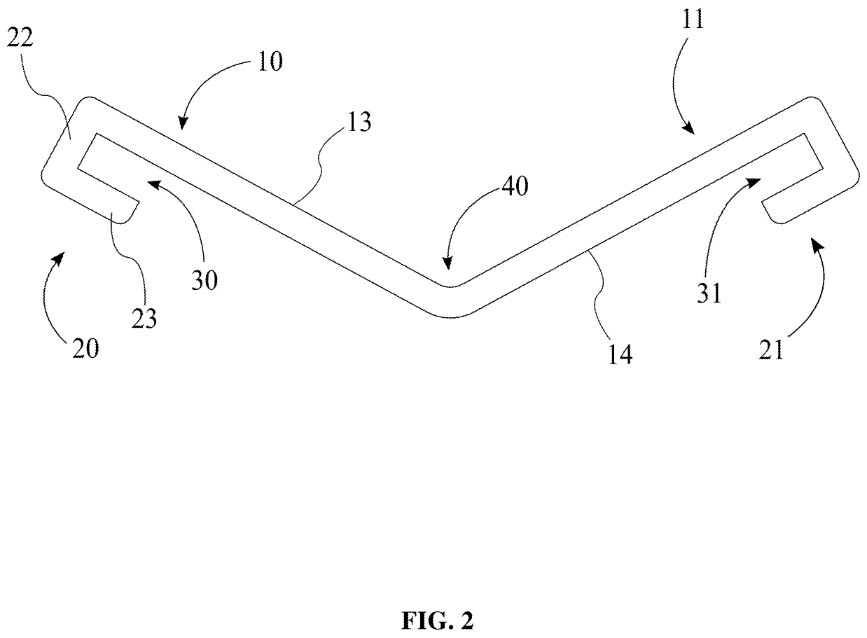

As can be seen in FIG. 1 to FIG. 2, the modular jack head isolator for protecting a workpiece from undesired damages comprises a first major planar member 10, a second major planar member 11, a first hook 20, a second hook 21, and a vertex 40. More specifically, the first major planar member 10 and the second major planar member 11 are terminally and angularly connected to each other, wherein the first major planar member 10 and the second major planar member 11 are joined by the vertex 40. Thus, the first major planar member 10 and the second major planar member 11 are oriented at a specified angle to each other, wherein the specified angle between the first major planar member 10 and the second major planar member 11 forms the vertex 40. The first major planar member 10 and the second major planar member 11 each comprises a top surface 13 and a bottom surface 14. Forming the top surface 13 of the present invention and abutted or mirror one another about the vertex 40 are the first major planar member 10 and the second major planar member 11 that can be inclined to one another to form a V-groove profile when viewed from the front. The first major planar member 10 and the second major planar member 11 may further preferably be made of a uniform material that is non-conductive to electricity, but structurally rigid enough to maintain an arbitrary but sizable load thereon when rendered onto the head of the pipe-jack stand or a similar V-groove implement with a columnar support thereunder. Centered between the first major planar member 10 and the second major planar member 11 is the vertex 40. The vertex 40 would preferably be located at the longitudinal center of the apparatus and adjoin both of the first major planar member 10 and the second major planar member 11. Further, the vertex 40 would be forming the bottom of the V-groove of the top half of the apparatus. The first hook 20 is terminally connected to the first major planar member 10 opposite the second major planar member 11 along the first major planar member 10. Additionally, the first hook 20 is positioned adjacent to the bottom surface 14 of the first major planar member 10. The second hook 21 is terminally connected to the second major planar member 11 opposite the first major planar member 10 along the second major planar member 11, and the second hook 21 is positioned adjacent to the bottom surface 14 of the second major planar member 21. Further, the first hook 20 and the second hook 21 are configured to receive a first end and a second end of the jack head of the pipe-jack stand, respectively. More specifically, the first major planar member 20 and the second major planar member 21 are configured to form a V-groove profile about the vertex 40 of the present invention.

As can be seen in FIG. 1 to FIG. 2, each of the first hook 20 and the second hook 21 of the present invention comprises a connecting member 22 and a minor planar member 23. Disposed beneath the plurality of first major planar member 10 and the second major planar member 11 and normal thereto on each respective half of the apparatus is the minor planar member 23. The minor planar member 23 would be disposed on each end of first major planar member 10 and the second major planar member 11 and adjoined to the connecting member 22 at a right angle thereof on each respective half of the apparatus. The minor planar member 23 would be possessed of an arbitrary length along the longitudinal dimension of the apparatus but preferably lesser in length than each of the first major planar member 10 and the second major planar member 11 to afford a slot disposed where a second vertex would have persisted if the minor planar member 23 of each of the first hook 20 and the second hook 21 converged. Further, the minor planar 23 would render flush to the underside of an extraneous pipe-jack stand or V-groove implement and restrict the apparatus from being pulled upward from the extraneous pipe-jack stand or V-groove implement. More specifically, the connecting member 22 of the first hook 20 is perpendicularly connected to the first major planar member 10. The minor planar member 23 of the first hook 20 is perpendicularly connected to the connecting member 23 of the first hook 20 opposite the first major planar member 10. The connecting member 22 of the second hook 21 is perpendicularly connected to the second major planar member 11, and the minor planar member 23 of the second hook 21 is perpendicularly connected to the connecting member 22 of the second hook 21 opposite the second major planar member 11.

Additionally, the modular jack head isolator of the present invention comprises a first recess 30 and a second recess 31. Formed by the boundaries set by the first major planar member 10 and the first hook 20 is the first recess 30, while the second recess 31 is formed by the second major planar member 11 and the second hook 21. The first recess 30 and the second recess 31 can suit the outward distal edges of the extraneous pipe-jack stand or -groove implement. Additionally, the first recess 30 and the second recess 31 would preferably form a rectilinear profile that is facing toward the vertex 40 and the midpoint of the apparatus. In other embodiments of the present invention, the first recess 30 and the second recess 31 may be provided a frictional surface thereon that limits the motion the apparatus can attain without sufficient force to remove the apparatus from the extraneous pip-jack stand or V-groove implement. More specifically, the first recess 30 is delineated by the first major planar member 10, the connecting member 22 of the first hook 20, and the minor planar member 23 of the first hook 20. Similarly, the second recess 31 is delineated by the second major planar member 11, the connecting member 22 of the second hook 21, and the minor planar member 23 of the second hook 2l. Further, the first recess 30 and the second recess 31 are configured to receive the first end and the second end of the jack head, respectively.

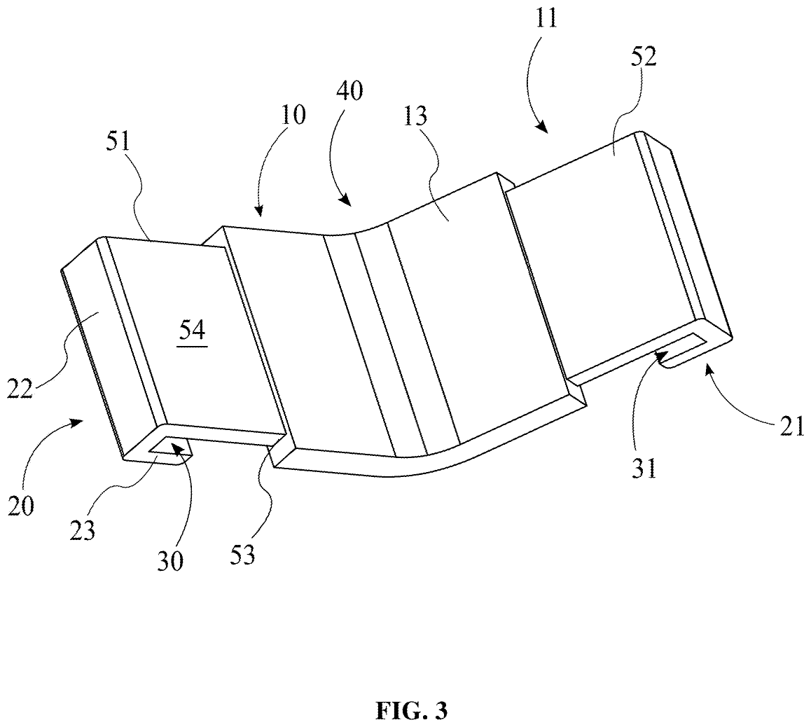

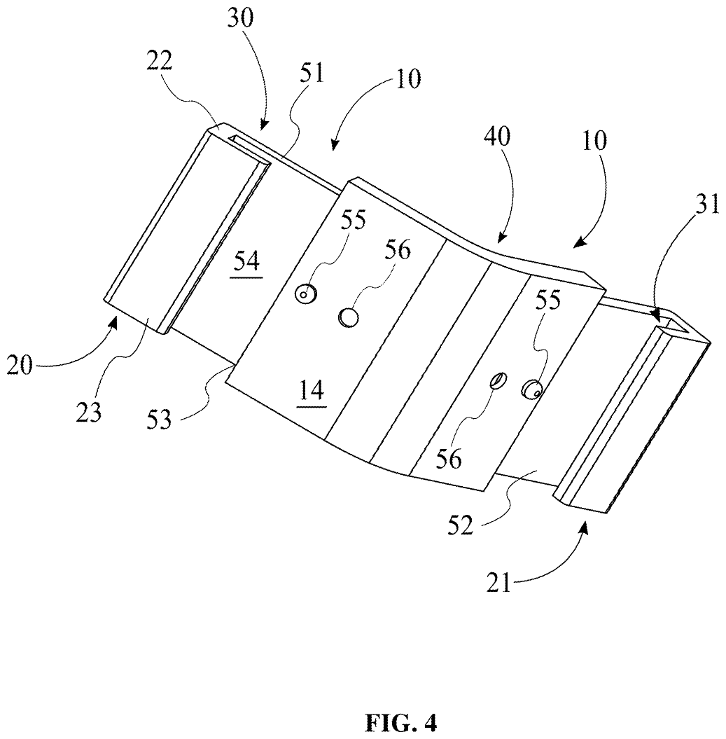

As can be seen in FIG. 3 to FIG. 4, the first major planar member 10 comprises a first telescoping member 51, and the second major planar member 11 comprises a second telescoping member 52. The first telescoping member 51 and the second telescoping member 52 permit the first major planar member 10 and the second major planar member 11 to become extensible and thus modularly alter the longitudinal dimension of the present invention. The first telescoping member 51 and the second telescoping member 52 may include the outer-most half of the telescoping structure near the vertex 40 to maintain a profile identical to the first major planar member 10 and the second major planar member 11, and the inner half of the telescoping structure furthest from the vertex 40 and adjoined to the first hook 20 and the second hook 21 on each half of the apparatus. Additionally, each of the first telescoping member 51 and the second telescoping member 52 comprises a telescoping aperture 53 and a telescoping protrusion 54. Preferably bored through the longitudinal direction of each of the first major planar member 10 and the second major planar member 11 toward the vertex 40 and half nearest thereto is the telescoping aperture 53. The telescoping aperture 53 can accommodate the telescoping protrusion 54 and permit limited translation therewith. Additionally, the telescoping aperture 53 preferably includes an aperture-profile offset with the cross-sectional profile of each of the first major planar member 10 and the second major planar member 11 itself. The telescoping aperture 53 may further therein comprise one of the plurality of retractable locking pins 55 or one of the plurality of pin holes 45 that restricts the extension of the telescoping protrusion 54 and restricting decoupling therefrom. Forming the second half of the each of the first telescoping member 51 and the second telescoping member 52 and coupled with the telescoping aperture 53 is the telescoping protrusion 54. The telescoping protrusion 54 would be complementing to the telescoping aperture 53 and translational therein. The telescoping protrusion 54 would be preferably located furthest from the vertex 40 and adjoined at the outermost edge to the each of the first hook 20 and the second hook 21. The telescoping protrusion 54 may further preferably possess a perimetric protrusion or rim that would prevent the telescoping protrusion 54 from disengaging from the telescoping aperture 53. More specifically, the telescoping aperture 53 is positioned within each of the first telescoping member 51 and the second telescoping member 52 adjacent the vertex 40. The telescoping protrusion 54 is terminally positioned on each of the first telescoping member 51 and the second telescoping member 52. And the telescoping protrusion 54 is slidably connected to the telescoping aperture 53. Further, the first telescoping member 51 and second telescoping member 52 each comprises a plurality of retractable locking pins 55 and a plurality of pin holes 56. More specifically, the plurality of retractable locking pins 55 and a plurality of pin holes 56 are positioned on the bottom surface 14 of each of the first telescoping member 51 and second telescoping member 52. Additionally, each of the plurality of retractable locking pins 55 is configured to retractably engage with one of the plurality of pin holes 56 so that the present invention can be locked in place when fit into the jack head of the pipe-jack stand per the actual length. In one embodiment of the present invention, the plurality of retractable locking pins 55 is positioned on the telescoping protrusion 54 while the plurality of pin holes 56 is positioned on the telescoping aperture 53. In another embodiment, the plurality of retractable locking pins 55 is positioned on the telescoping aperture 53 while the plurality of pin holes 56 positioned on the telescoping protrusion 54.

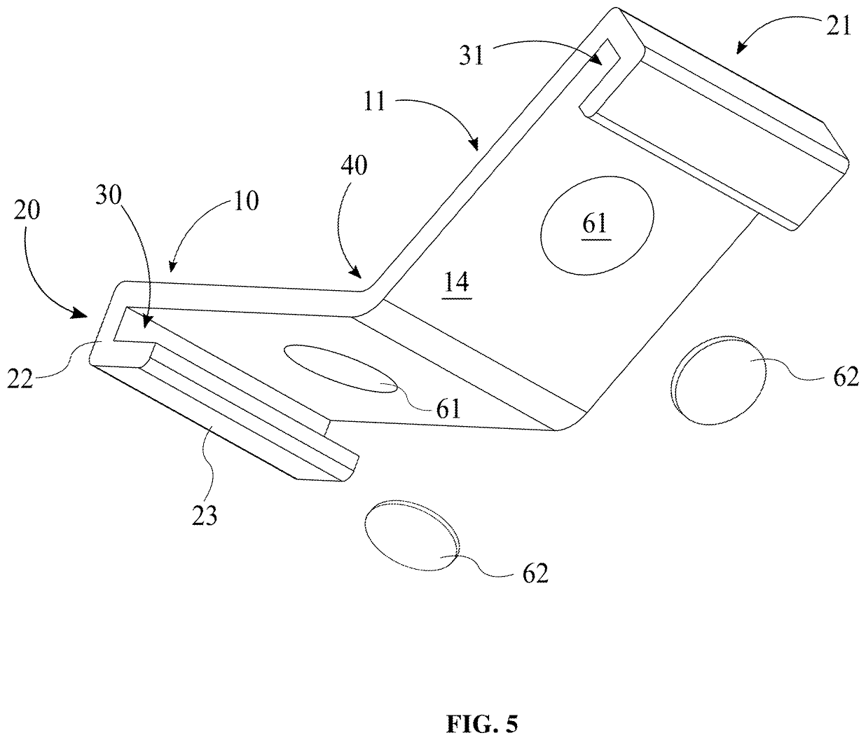

As can be seen in FIG. 5, the first major planar member 10 and the second major planar member 11 each comprises a plurality of magnet cavities 61 and a plurality of magnets 62. The plurality of magnet cavities 61 is positioned on the bottom surface 14 of each of the first major planar member 10 and the second major planar member 11. Additionally, each of the plurality of magnets 62 is mounted to one of the plurality of magnet cavities 61. More specifically, the plurality of magnet cavities 61 may be disposed on the bottom half of each of the first major planar member 10 and the second major planar member 11. The plurality of magnets 62 may be coupled thereto through a magnet fastening means. Preferably the plurality of magnet cavities 61 would be in a count of two total with one to each of the first major planar member 10 and the second major planar member 11, and be recessed greater than the height of each of plurality of the magnets 62 to leave the underlying first recess 30 and second recess 31 unhindered. The plurality of magnet cavities 62 would further preferably be curvilinear in profile, although other profiles may be used such as rectilinear, trilinear, and so on, provided the magnet's profile is complementing. While preferably the plurality of magnet cavities 61 would be disposed on the bottom half of each of the first major planar member 10 and the second major planar member 11, the plurality of magnet cavities 61 may also be provided and bored through the longitudinal edge of each of the first major planar member 10 and the second major planar member 11 with the magnet slotted therein to leave only the front surface of the apparatus open to receive a magnet and the top surface 13 and bottom surface 14 uniformly flush. Further, although preferably a single magnet cavity may be disposed on both of the first major planar member 10 and the second major planar member 11, the plurality of magnet cavities 61 may be of a count greater than two in total, with clusters provided arbitrarily throughout each of the first major planar member 10 and the second major planar member 11 such as, but not limited to, about the longitudinal edges, along the lateral edges, about the four corners of each of the first major planar member 10 and the second major planar member 11, and so on.

Secured within each of the plurality of magnet cavities 61 is one of the plurality of magnets 62 that would possess a complementing geometry to the corresponding magnet cavity 61 and secured thereto through the magnet fastening means. The plurality of magnets 62 may be provided to attract to the generally metallic structure that comprises the pipe-jack head and limiting motion therewith. Coupling the plurality of magnets 62 within the respective magnet cavity of the plurality of magnet cavities 61 is the magnet fastening means. The magnet fastening means may preferably be modular in scope such as tolerance fitting, snap fitting means, self-locating geometry, and so on. However, the magnet fastening means may be permanent fastening means such as, but not limited to, adhesives, embedding, melded to the major planar member, and so on.

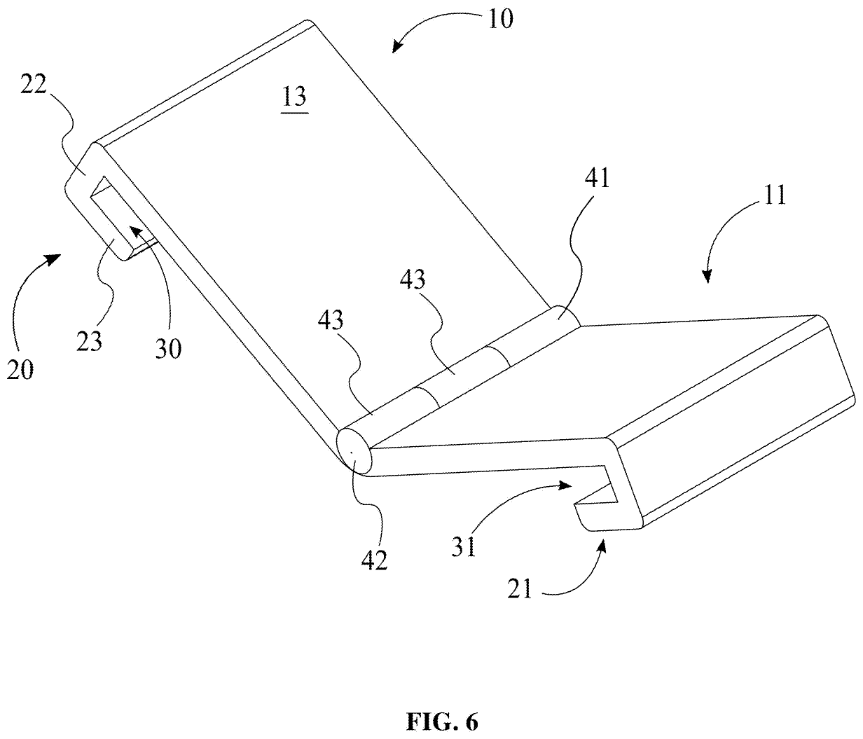

As can be seen in FIG. 6, the vertex 40 comprises a locking hinge 41. The locking hinge 41 is configured to enable each of the first major planar member and the second major planar member to rotate to and lock at any angle around the apex. More specifically, the locking hinge 41 may be located at or substituted with the vertex 40. The locking hinge 41 can afford the present invention the ability to hinge and alter the inclination of the first major planar member 10 and the second major planar member 11 with one another. The locking hinge 41 may be provided alongside each of the first telescoping member 51 and the second telescoping member 52 to offer a truly modular jack head isolator for a V-groove of varying size or tolerance. Preferably, the locking hinge 41 permits the first major planar member 10 and the second major planar member 11 to become parallel with one another and flush therewith when fully collapsed and extend at least 90 degrees on either half of the apparatus to render the two major planar members coplanar with one another. The locking hinge 41 can further arrest the rotation of the locking hinge 41 when selectively locked. Additionally, the locking hinge 41 comprises an axle 42, a plurality of hinge protrusions 43, and a hinge axle aperture 44. The plurality of hinge protrusions 43 is exteriorly and cylindrically positioned on the locking hinge 41, thus forming the hinge axle aperture 44, which is centrally positioned on the locking hinge 41. The axle 42 is concentrically mounted inside the hinge axle aperture 44. Additionally, each of the plurality of hinge protrusions 43 is terminally connected to both the first major planar member 10 and the second major planar member 11 to allow each of the first major planar member 10 and the second major planar member 11 to rotate to any angle therebetween and to be locked for fitting into the jack head of the pipe-jack stand. Further, the hinge axle aperture 44 of the locking hinge 41 comprises a locking mechanism, positioned within the hinge axle aperture 44, that arrests the rotational motion of either the first major planar member 10 or the second major planar member 11 to the other. The axle 42 is configured to restrict the translational motion of the axle 42 within the hinge axle aperture 44 while permitting the rotation of the plurality of hinge protrusions 43 to one another and subsequently the first major planar member 10 or the second major planar member 11.

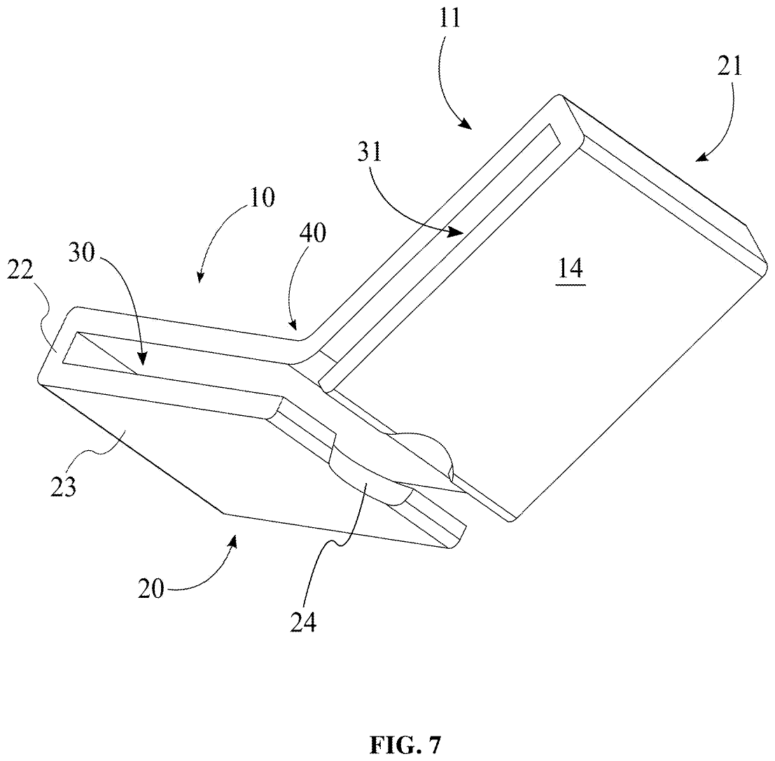

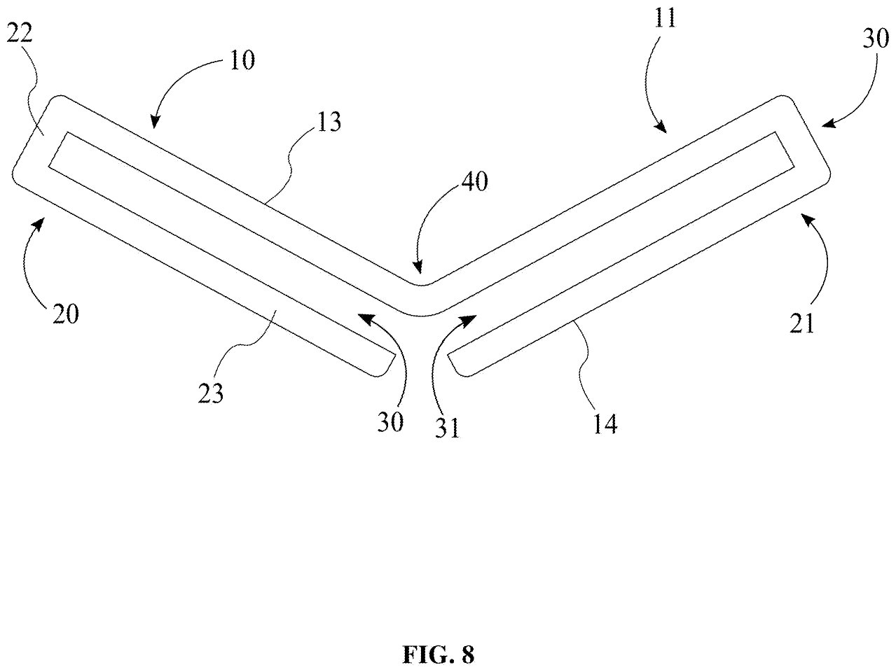

As can be seen in FIG. 7 to FIG. 8, the minor planar member 23 of each of the first hook 20 and the second hook 21 comprises a column recess 24. More specifically, the column recess 24 is centrally positioned on the edge of the minor planar member 23 of each of the first hook 20 and the second hook 21, opposite the connecting member 22. The column recess 24 can provide a composite profile that suits a central columnar element of the extraneous pipe-jack stand or other V-groove implement with a columnar support thereunder. The column recess 24 may require the minor planar member 23 of each of the first hook 20 and the second hook 21 to be substantially but arbitrarily longer than the span of the minor planar member 23 of each of the first hook 20 and the second hook 21 in the preferred embodiment and nearing convergence therewith as seen in FIG. 7 to FIG. 8. However, preferably the minor planar member 23 of each of the first hook 20 and the second hook 21 would still be kept from converging to each other to permit the underlying columnar element of the pipe-jack stand or other V-groove implement to be slid therethrough, thereafter snapping into the column recess 24 to arrest motion of the present invention until sufficient force is imparted to remove the present invention from the pipe-jack stand head or other V-groove implements.

Although the invention has been explained in relation to its preferred embodiment, it is to be understood that many other possible modifications and variations can be made without departing from the spirit and scope of the invention as hereinafter claimed.

What is claimed is:

1. A modular jack head isolator for protecting workpieces from undesired damages comprising:
a first major planar member;
a second major planar member;
a first hook;
a second hook;
the first major planar member and the second major planar member being terminally and angularly connected to each other, wherein the first major planar member and the second major planar member are joined by a vertex;
the first major planar member and the second major planar member each comprising a top surface and a bottom surface;
the first hook being terminally connected to the first major planar member opposite the second major planar member along the first major planar member;
the first hook being positioned adjacent to the bottom surface of the first major planar member;
the second hook being terminally connected to the second major planar member opposite the first major planar member along the second major planar member;
the second hook being positioned adjacent to the bottom surface of the second major planar member; and
the first hook and the second hook being configured to receive a first end and a second end of a jack head, respectively.

2. The modular jack head isolator for protecting workpieces from undesired damages as claimed in claim 1, wherein the first major planar member and the second major planar member being configured to form a V-groove profile about the vertex.

3. The modular jack head isolator for protecting workpieces from undesired damages as claimed in claim 1 comprising:
the first hook and the second hook each comprising a minor planar member and a connecting member;
the connecting member of the first hook being perpendicularly connected to the first major planar member;
the minor planar member of the first hook being perpendicularly connected to the connecting member of the first hook opposite the first major planar member;
the connecting member of the second hook being perpendicularly connected to the second major planar member; and
the minor planar member of the second hook being perpendicularly connected to the connecting member of the second hook opposite the second major planar member.

4. The modular jack head isolator for protecting workpieces from undesired damages as claimed in claim 3 comprising:
a first recess being delineated by the first major planar member, the connecting member of the first hook, and the minor planar member of the first hook;
a second recess being delineated by the second major planar member, the connecting member of the second hook, and the minor planar member of the second hook; and
the first recess and the second recess being configured to receive the first end and the second end of the jack head, respectively.

5. The modular jack head isolator for protecting workpieces from undesired damages as claimed in claim 1 comprising:
the first major planar member and the second major planar member being oriented at a specified angle to each other, wherein the specified angle between the first major planar member and the second major planar member forms a vertex.

6. The modular jack head isolator for protecting workpieces from undesired damages as claimed in claim 1 comprising:
the first major planar member comprising a first telescoping member;
the second major planar member comprising a second telescoping member;
each of the first telescoping member and the second telescoping member comprising a telescoping aperture and a telescoping protrusion;
the telescoping aperture being positioned within each of the first telescoping member and the second telescoping member adjacent the vertex;
the telescoping protrusion being terminally positioned on each of the first telescoping member and the second telescoping member; and
the telescoping protrusion being slidably connected to the telescoping aperture.

7. The modular jack head isolator for protecting workpieces from undesired damages as claimed in claim 6 comprising:
the first telescoping member and second telescoping member each comprising a plurality of retractable locking pins and a plurality of pin holes;
the plurality of retractable locking pins and a plurality of pin holes being positioned on the bottom surface of each of the first telescoping member and second telescoping member; and
each of the plurality of retractable locking pins being configured to retractably engage with one of the plurality of pin holes.

8. The modular jack head isolator for protecting workpieces from undesired damages as claimed in claim 7 comprising:
the plurality of retractable locking pins being positioned on the telescoping protrusion; and
the plurality of pin holes being positioned on the telescoping aperture.

9. The modular jack head isolator for protecting workpieces from undesired damages as claimed in claim 7 comprising:
the plurality of retractable locking pins being positioned on the telescoping aperture; and
the plurality of pin holes being positioned on the telescoping protrusion.

10. The modular jack head isolator for protecting workpieces from undesired damages as claimed in claim 1 comprising:
the first major planar member and the second major planar member each comprising a plurality of magnet cavities and a plurality of magnets;
the plurality of magnet cavities being positioned on the bottom surface of each of the first major planar member and the second major planar member; and
each of the plurality of magnets being mounted to one of the plurality of magnet cavities.

11. The modular jack head isolator for protecting workpieces from undesired damages as claimed in claim 1 comprising:
the vertex comprising a locking hinge; and
the locking hinge being configured to enable the plurality of each of the first major planar member and the second major planar member to rotate to and lock at any angle around the apex.

12. The modular jack head isolator for protecting workpieces from undesired damages as claimed in claim 11 comprising:
the locking hinge comprising a hinge aperture, an axle, a plurality of hinge protrusions, and a hinge axle aperture;
the plurality of hinge protrusions being exteriorly and cylindrically positioned on the locking hinge;
the plurality of hinge protrusions being terminally connected to both first major planar member and the second major planar member;
the hinge aperture being centrally positioned on the locking hinge; and
the axle being concentrically mounted inside the hinge aperture;

13. The modular jack head isolator for protecting workpieces from undesired damages as claimed in claim 11, wherein the locking hinge comprising a locking mechanism.

14. The modular jack head isolator for protecting workpieces from undesired damages as claimed in claim 1 comprising:
minor planar member of each of the first hook and the second hook comprising a column recess;
the column recess being centrally positioned edge of the minor planar member of each of the first hook and the second hook, opposite the connecting member; and
wherein the column recess being configured to suit a central columnar element of a jack stand with a columnar support thereunder.

15. A modular jack head isolator for protecting workpieces from undesired damages comprising:
a first major planar member;
a second major planar member;
a first hook;
a second hook;
the first major planar member and the second major planar member being terminally and angularly connected to each other, wherein the first major planar member and the second major planar member are joined by a vertex;
the first major planar member and the second major planar member each comprising a top surface and a bottom surface;
the first hook being terminally connected to the first major planar member opposite the second major planar member along the first major planar member;
the first hook being positioned adjacent to the bottom surface of the first major planar member;
the second hook being terminally connected to the second major planar member opposite the first major planar member along the second major planar member;
the second hook being positioned adjacent to the bottom surface of the second major planar member;
the first hook and the second hook being configured to receive a first end and a second end of a jack head, respectively;
the first major planar member comprising a first telescoping member;
the second major planar member comprising a second telescoping member;
each of the first telescoping member and the second telescoping member comprising a telescoping aperture and a telescoping protrusion;
the telescoping aperture being positioned within each of the first telescoping member and the second telescoping member adjacent the vertex;
the telescoping protrusion being terminally positioned on each of the first telescoping member and the second telescoping member; and
the telescoping protrusion being slidably connected to the telescoping aperture.

16. The modular jack head isolator for protecting workpieces from undesired damages as claimed in claim 15 comprising:
the first telescoping member and second telescoping member each comprising a plurality of retractable locking pins and a plurality of pin holes;
the plurality of retractable locking pins and a plurality of pin holes being positioned on the bottom surface of each of the first telescoping member and second telescoping member; and
each of the plurality of retractable locking pins being configured to retractably engage with one of the plurality of pin holes.

17. The modular jack head isolator for protecting workpieces from undesired damages as claimed in claim 16 comprising:
the plurality of retractable locking pins being positioned on the telescoping protrusion; and
the plurality of pin holes being positioned on the telescoping aperture.

18. The modular jack head isolator for protecting workpieces from undesired damages as claimed in claim 16 comprising:
the plurality of retractable locking pins being positioned on the telescoping aperture; and
the plurality of pin holes being positioned on the telescoping protrusion.

19. A modular jack head isolator for protecting workpieces from undesired damages comprising:
a first major planar member;
a second major planar member;
a first hook;
a second hook;
the first major planar member and the second major planar member being terminally and angularly connected to each other, wherein the first major planar member and the second major planar member are joined by a vertex;
the first major planar member and the second major planar member each comprising a top surface and a bottom surface;
the first hook being terminally connected to the first major planar member opposite the second major planar member along the first major planar member;
the first hook being positioned adjacent to the bottom surface of the first major planar member;
the second hook being terminally connected to the second major planar member opposite the first major planar member along the second major planar member;
the second hook being positioned adjacent to the bottom surface of the second major planar member;
the first hook and the second hook being configured to receive a first end and a second end of a jack head, respectively;
the vertex comprising a locking hinge; and
the locking hinge being configured to enable the plurality of each of the first major planar member and the second major planar member to rotate to and lock at any angle around the apex.

20. The modular jack head isolator for protecting workpieces from undesired damages as claimed in claim 19 comprising:
the locking hinge comprising a hinge aperture, an axle, a plurality of hinge protrusions, and a hinge axle aperture;
the plurality of hinge protrusions being exteriorly and cylindrically positioned on the locking hinge;
the plurality of hinge protrusions being terminally connected to both first major planar member and the second major planar member;
the hinge aperture being centrally positioned on the locking hinge; and
the axle being concentrically mounted inside the hinge aperture;
